(19) United States
(12) Patent Application Publication
(10) Pub. No.: US 2011/0225079 A1
(43) Pub. Date: Sep. 15, 2011

(54) METHOD AND SYSTEM FOR PERSONALIZED EDUCATION

(75) Inventor: Liz Davidson, Manhattan Beach, CA (US)

(73) Assignee: FINANCIAL FINESSE, INC., Manhattan Beach, CA (US)

(21) Appl. No.: 13/091,959

(22) Filed: Apr. 21, 2011

Related U.S. Application Data
(63) Continuation-in-part of application No. PCT/US09/61551, filed on Oct. 21, 2009.
(60) Provisional application No. 61/107,222, filed on Oct. 21, 2008.

(51) Int. Cl. G06Q 40/00; G06F 17/30

(52) U.S. Cl. 705/35; 707/805; 707/E17.03

(57) ABSTRACT

The present invention is directed to methods and systems for producing educational material on a specific topic of interest. More specifically, the invention relates to an automated platform for providing specific financial information, through a graphic user interface, responsive to an end user's query. The invention is operative to generate financial wellness assessments and education plans personalized for individuals. The invention also includes systems and methods for aggregating and analyzing responses of a plurality of associated users to generate financial wellness assessment reports for associations (e.g., employers). Associations using this aggregated and analyzed data are therefore able to design an effective and impactful financial education program for their members.

### CROSS REFERENCE TO RELATED APPLICATIONS

This application is a continuation-in-part of International Application No. PCT/US09/61551, filed Oct. 21, 2009, which claims the benefit of U.S. Provisional Application No. 61/107,222, filed Oct. 21, 2008.

### FIELD OF THE INVENTION

The field of the present invention relates to a method and system for providing personalized educational material to an end user. More specifically, the invention relates to an automated platform for providing pertinent financial information, through a graphic user interface, responsive to the end user's query, and for analyzing responses to financially-related questions provided by end users.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

The computer and internet have become critical tools for educating and providing information to the general public on virtually all topics. As finance and investment information has traditionally been reserved for individuals able to afford the knowledge, many have turned to the internet as a frugal alternative for educating themselves regarding finance and investing. However, given the unlimited number of variables associated with each individual's financial state throughout various stages in life, the ability to provide financial enlightenment tailored for each individual has been very difficult to provide and often labor intensive to achieve.

One of the greatest attributes of the computer is the ability to process and analyze information in a fraction of the time required for these calculations to be performed manually. Of course, in order to allow a computer to perform useful functions, and optimize such functions, software designed with efficient and specific functionality is particularly critical. Such software is often referred to as a “tool.” The architecture or framework behind the tool is often described as a “platform.” The platform allows application of the tool, and typically incorporates the computer's architecture, operating system, programming languages and related runtime libraries or graphical user interface.

The current methods for financial education may incorporate a platform which uses an online search engine, database, corporate manuals, or other data sources to provide information which may be relevant to the end user's topic of interest. For example, an end user may input his topic of interest and the search engine may examine its index and provide a listing of best-matching web pages according to the search engine's criteria. Alternatively corporate policies and manuals may be reviewed to produce information corresponding to the end user's inputted query.

In mining for information, most search engines implement the use of Boolean operators (e.g. and, or, not) or proximity searches to specify the search query. However, these restrictions are not always fruitful as search engines regularly identify the relevance of a webpage based on third-party ratings or employ methods to rank the results to provide the “best” results first. Furthermore, the methodologies used by search engines in determining what information best matches an end user's topic of interest, and what order the information should be presented, is influenced by conflicting variables, such as sponsored links and popularity. The unrestricted flow of information and the ability for end users to download information, as well as misinformation, has led to an unreliable and unrestricted pool of data. As internet search engines have morphed to better siphon the data and produce focused rather than relevant information to end users, the level of sophistication and organization required to distinguish and identify the pertinence of the information, as well as misinformation, has yet to be implemented with efficiency.

Accordingly, the current methods and systems for producing educational material on a specific topic of interest are rarely responsive and oftentimes occupy the end user's time with frivolous advertising and superfluous information rather than specific information. These frustrations commonly result in an extended investment of time and effort on the part of end users to educate themselves regarding a specific topic of interest.

Due to the disadvantages associated with the current methods and systems for providing relevant educational information to an end user, there exists a need for an education method and system that is capable of delivering specific information to an end user. There is a further need for a method and system to distinguish and catalog educational materials by subject, category, and sub-category, and identify and address the specific topic of interest of the end user efficiently, thus providing the end user with educational material that is parallel with the topic of interest.

### SUMMARY OF THE INVENTION

The invention relates to methods and systems for providing personalized educational material responsive to an end user's chosen topic of interest. The methods and systems capture and digest various inputs provided by the end user, and determine specific finance, investing and finance management topics of interest relevant to the end user. The topics of interest are determined using at least one computer based topic algorithm which analyzes the end user's inputs. Relevant educational materials are captured and analyzed from a database and cataloged using a computer based catalog algorithm. A correspondence algorithm correlates the cataloged educational materials with the end user's topic of interest, producing personalized educational materials coinciding with the end user's topic of interest. The educational materials are related to the field of finance, investing and finance management.

The invention also relates to methods and systems for providing an end user with an assessment of their financial wellness based on the user's response to a plurality of questions. The assessment may include one or more scores, comparisons to other users, vulnerabilities, and plans for action. Additionally, the assessment may provide educational materials to the user based on responses to financial wellness related questions.

The invention also relates to methods and systems for aggregating and analyzing responses from a plurality of associated users (e.g., employees of a company or other organization). The results of the analyzed responses may be provided to an organization in a variety of useful formats. By capturing user-provided financial wellness information and analyzing it, companies or other organizations may determine how to best design effective and impactful financial education programs for their employees.

An embodiment of the present invention provides a method for providing educational material in response to an end user's input, the method comprising accessing a database for educational materials, analyzing and cataloging the educational materials found in the database, querying the end user to identify a topic of interest based on the end user's response to the query, identifying educational material from the database corresponding with the identified topic of interest, and presenting educational material to the end user through a graphic user interface (GUI).

In an embodiment of the invention, the database may be in communication with a network. In addition the database may comprise a catalog, a corporate manual, an electronic data source, or combinations thereof.

In an embodiment of the invention, the step of querying the end user may comprise soliciting a response to a question, prompting a selection from at least two choices, prompting a response to a yes/no question, soliciting an input, or combinations thereof.

In an embodiment of the invention, the step of identifying at least one topic of interest based on the results of the query comprises the use of a topic algorithm.

In an embodiment of the invention, the step of analyzing educational material from the database relevant to various topics of interests may comprise the use of an analysis algorithm.

In an embodiment of the invention, the step of cataloging educational material from the database corresponding with at least one topic of interest may comprise the use of a catalog algorithm.

In an embodiment of the invention the topic of interest is finance, investing, financial planning, finance management, or combinations thereof.

In an embodiment of the invention, the database may be supplemented with additional educational material.

In an embodiment of the invention, the step of identifying educational material corresponding with the at least one topic of interest may comprise the use of a correspondence algorithm.

In an embodiment of the invention, the method may further comprise calculating a financial wellness score based on the results of the query by weighing the results against optimal wellness criteria in a plurality of areas of personal finance.

An embodiment of the present invention provides a computer-usable medium having readable instructions stored thereon that when executed by a processor perform a method for providing educational material in response to an end user's input, the method comprising accessing a database of educational materials, analyzing and cataloging the educational materials found in the database, querying the end user to identify a topic of interest based on the end user's response to the query, identifying educational material from the database corresponding with the identified topic of interest, and presenting the corresponding educational material to the end user through a graphic user interface (GUI).

In an embodiment of the invention, the database may be in communication with a network. In addition the database may comprise a catalog, a corporate manual, an electronic data source, or combinations thereof.

In an embodiment of the invention, the step of querying the end user may comprise soliciting a response to a question, prompting a selection from at least two choices, prompting a response to a yes/no question, soliciting an input, or combinations thereof.

In an embodiment of the invention, the step of identifying at least one topic of interest based on the results of the query comprises the use of a topic algorithm.

In an embodiment of the invention, the step of analyzing educational material from the database relevant to various topics of interests may comprise the use of an analysis algorithm.

In an embodiment of the invention, the step of cataloging educational material from the database corresponding with at least one topic of interest may comprise the use of a catalog algorithm.

In an embodiment of the invention, the topic of interest is finance, investing, financial planning, finance management, or combinations thereof.

In an embodiment of the invention, the database may be supplemented with additional educational material.

In an embodiment of the invention the step of identifying educational material corresponding with the at least one topic of interest may comprise the use of a correspondence algorithm.

An embodiment of the invention provides a method for providing a financial wellness assessment to a user, comprising: presenting a plurality of questions to the user through a graphical user interface (GUI), the questions relating to one or more financial topics; receiving responses to the plurality of questions from the user; analyzing the responses received from the user according to a predetermined algorithm; comparing the responses received from the user to a larger sample of responses; determining an overall financial wellness score of the user based on the user's responses to the plurality of questions and predetermined financial wellness criteria; presenting the overall financial wellness score to the user through the GUI; and presenting to the user a comparison of a financial characteristic between the user and the larger sample.

In an embodiment of invention, the method of calculating the unique financial wellness score based on the input received from the user includes calculating the wellness score components for each of the major personal finance areas of concern (such as debt management, cash flow, retirement, investing etc.) as well as overall score for the user; using such score as the objective metrics of the user's financial well-being; and using such score for comparing the user's financial wellness to other users in the group and/or nationwide.

In an embodiment of the invention, the method includes identifying at least one topic of interest based on the responses received from the user; identifying educational material corresponding with the at least one topic of interest; and presenting the corresponding educational material to the user through the GUI.

In an embodiment of the invention, the method includes identifying at least one vulnerability of the user based on the responses received from the user; and presenting educational material corresponding to the identified vulnerability to the user through the GUI.

In an embodiment of the invention, at least one of the plurality of questions relates to the user's priorities regarding financial topics, and the method further comprising presenting a comparison between the user and the larger sample relating to a financial topic that the user has indicated to be a priority.

An embodiment of the invention provides a method for providing a financial wellness assessment report for an association, comprising: receiving a plurality of responses to a financial wellness assessment for a plurality of associated users; analyzing the responses in aggregate according to an algorithm to determine one or more financial wellness characteristics of the association; comparing the responses to a larger sample of responses; and providing results of the analysis to the association.

In an embodiment of the invention, the method includes an algorithm for calculating the financial wellness score for the association as an overall score and separate component scores for each of the personal finance areas of concern; and using said scores as objective metrics and key performance indicators to compare the association with the peers and/or nationwide averages as well as comparing various demographics slices within the association.

In an embodiment of the invention, the method includes providing a recommended financial education plan to the association based on the analyzed responses and the calculated financial wellness scores.

In an embodiment of the invention, providing results comprises providing results based on demographic information for the members of the association. In some embodiments, the demographic information includes one or more of age, income, gender, and geographic location.

An embodiment of the present invention provides a computer-usable medium having readable instructions stored thereon that when executed, cause a processor to perform a method for providing a financial wellness assessment report for an association, the method comprising: receiving responses to a financial wellness assessment for a plurality of associated users; analyzing the responses in aggregate according to an algorithm to determine one or more financial wellness characteristics of the association; comparing the responses to a larger sample of responses; and providing results of the analysis to the association.

An embodiment of the present invention provides a system for providing a financial wellness assessment report for an association, comprising: a computer comprising a processor operative to execute instructions to perform a method for providing a financial wellness assessment report for an association, the method comprising: receiving responses to a financial wellness assessment for a plurality of associated users; analyzing the responses in aggregate according to an algorithm to determine one or more financial wellness characteristics of the association; comparing the responses to a larger sample of responses received from other associations; and providing results of the analysis to the association.

Other features and advantages of the invention will become apparent from the following detailed description, taken in conjunction with the accompanying drawings, which illustrate, by way of example, various features of embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 is a diagram depicting a summary information to detailed data process, in accordance with an embodiment of the invention.

FIG. 2 is a diagram depicting a summary information to detailed data process, in accordance with an embodiment of the invention.

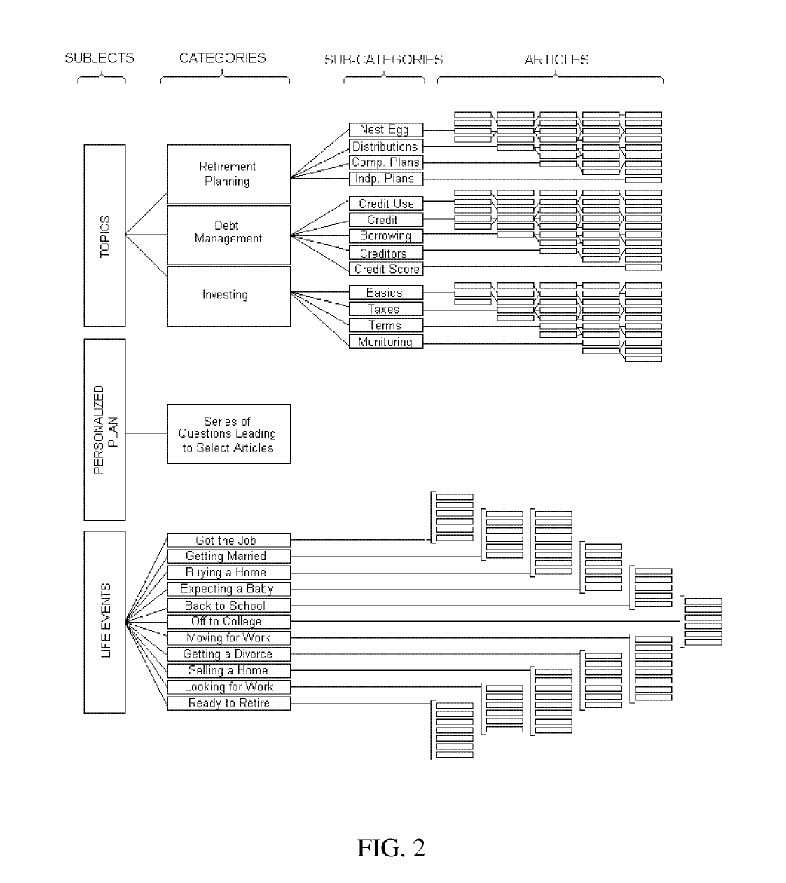

FIG. 3 is a flow chart depicting a personalized educational material selection process, in accordance with an embodiment of the invention.

FIG. 4 is a block diagram depicting exemplary components of a platform, in accordance with an embodiment of the invention.

FIG. 5 is a block diagram depicting exemplary components of a platform, in accordance with an embodiment of the invention.

FIG. 6 is a diagram of a process for generating and presenting a financial wellness assessment for a user in accordance with an embodiment of the invention.

FIG. 7 is a diagram illustrating a graphical user interface for presenting a financial wellness assessment to a user, in accordance with an embodiment of the invention.

FIG. 8 is a diagram of a process for generating and presenting a financial wellness assessment report for an organization, in accordance with an embodiment of the invention.

FIG. 9 is a diagram illustrating a graphical user interface for presenting a financial wellness assessment report for an organization, in accordance with an embodiment of the invention.

FIG. 10 is a diagram illustrating a graphical user interface of a score comparison for a financial wellness assessment report, in accordance with an embodiment of the invention.

FIG. 11 is a block diagram of a suggested financial education plan for an organization, in accordance with an embodiment of the invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which the invention belongs. One skilled in the art will recognize many methods and systems similar or equivalent to those described herein, which could be used in the practice of the invention.

One skilled in the art will recognize many methods and systems similar or equivalent to those described herein, which could be used in the practice of the present invention. Indeed, the present invention is in no way limited to the methods and systems described. For purposes of the present invention, the following terms are defined below.

“Algorithm” as used herein refers to an effective method for solving a problem using a finite sequence of instructions. Algorithms are used for calculation, data processing, and many other fields. Each algorithm is a list of well-defined instructions for completing a task. Starting from an initial state, the instructions describe a computation that proceeds through a well-defined series of successive states, eventually terminating in a final ending state.

“Network” as used herein refers to a global system of interconnected computer systems that use a standardized language for communication (e.g. Internet Protocol Suite-TCP/IP).

“Platform” as used herein describes some sort of hardware architecture or software framework (including application frameworks), that allows software to run. Typical platforms include a computer's architecture, operating system, programming languages and related runtime libraries or graphical user interfaces.

“Software” as used herein describes the role that computer programs, procedures and documentation play in a computer system. Software encompasses an extremely wide array of products and technologies developed using different techniques like programming languages, scripting languages, microcode, or an FPGA configuration.

Disclosed herein are methods and systems for providing personalized educational material responsive to an end user's query. The invention may use a computer-usable medium having readable instructions stored thereon that when executed by a processor found in the platform interact with an end user to provide education material. The invention provides a platform for interacting and establishing characteristics and criteria specific to the end user for determining the end user's topic of interest. The identified characteristics and criteria are used to cross-reference a database of educational materials, to determine those educational materials specific to the end user's query, and present the educational materials to the end user for edification.

The educational materials presented to the end user correspond with the topic of interest identified by the end user as pertinent, and aim to educate the end user in the specific topic of interest. The method for identification of specific topics of interest is based on a platform which typically incorporates a computer's architecture, operating system, programming languages and related runtime libraries or graphical user interface (“GUI”). The platform provides the backbone upon which determination of the end user's requested topic of interest is identified, as well as the means to decipher and provide educational information which correlates to the identified topic of interest. The platform is further capable of gathering relevant educational information from outside content/resources, internal and external databases, as well as other resources. Once gathered, the educational information is analyzed and cataloged by at least one computer based algorithm, according to subject, category, sub-category, and further finite groupings if necessary. The cataloged materials are then presented to the end user in response to its specific inputs determining the topic of interest.

In addition the present invention provides a computer-usable medium having readable instructions stored thereon that when executed by a processor found in the platform present the end user with educational materials specific to the end user's query. The computer-usable medium provides access to a database containing educational materials, a means for searching the database, and a catalog algorithm for establishing a catalog of finance related educational materials. The computer-usable medium captures information from the end user, and using a topic algorithm, determines a topic of interest based on the information received from the end user. Finally, the platform incorporates the use of a computer-implemented correspondence algorithm to cross-reference the topic of interest determined from querying the end user, with educational information cataloged, to present educational information relevant to the chosen topic of interest, through a graphic user interface.

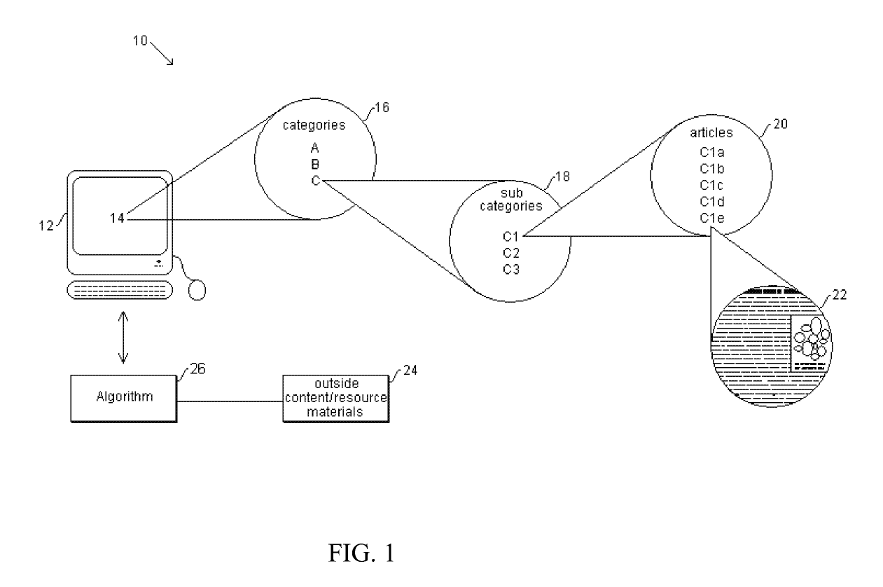

As an example, shown in FIG. 1, the end user interacts with the inventive financial education platform 10 through a GUI 12, or other appropriate medium know in the art. The GUI 12 provides at least one general financial subject 14 for selection by the end user. Once a general financial subject 14 is selected, at least one category 16 is available for selection by the end user to further narrow the type of financial information desired by the end user. Categories of financial information may include specific life events (such as buying a home or getting married), investing, retirement planning, or debt management, to name a few. Once a category 16 is chosen, at least one subcategory 18 is presented to the end user to further refine the financial information desired by the end user. Subcategories 18 are intended to provide more specific areas of interest within the chosen category 16 and allow the end user to further pinpoint the type of financial information sought. As an example, subcategories 18 may include: accumulating your nest egg; company sponsored retirement plans; making investment choices; and tax implications for investing. Once a subcategory 18 is selected, relevant articles and educational materials 20 are presented to the end user which may be opened in the GUI 12 and reviewed for edification 22.

The educational materials 20 presented for educating the end user may be gathered from outside content/resources 24 using the financial education platform 10 and at least one computer-based algorithm 26. Alternatively, the educational materials 20 may be uploaded directly onto the database, either to be cataloged or for cataloging by a catalog algorithm (not shown). The at least one algorithm 26 captures and analyzes the content/resource educational materials 20 and catalogs the content/resource materials 20 according to subject 14, category 16, subcategory 18, and other areas of interest according to keywords, if applicable. Individual content/resource materials 20 may be cataloged in multiple subjects 14, categories 16, subcategories 18, or combinations thereof. The materials 20 are then available for presentation to the end user based on the end user's selected preferences (e.g. categories and subcategories).

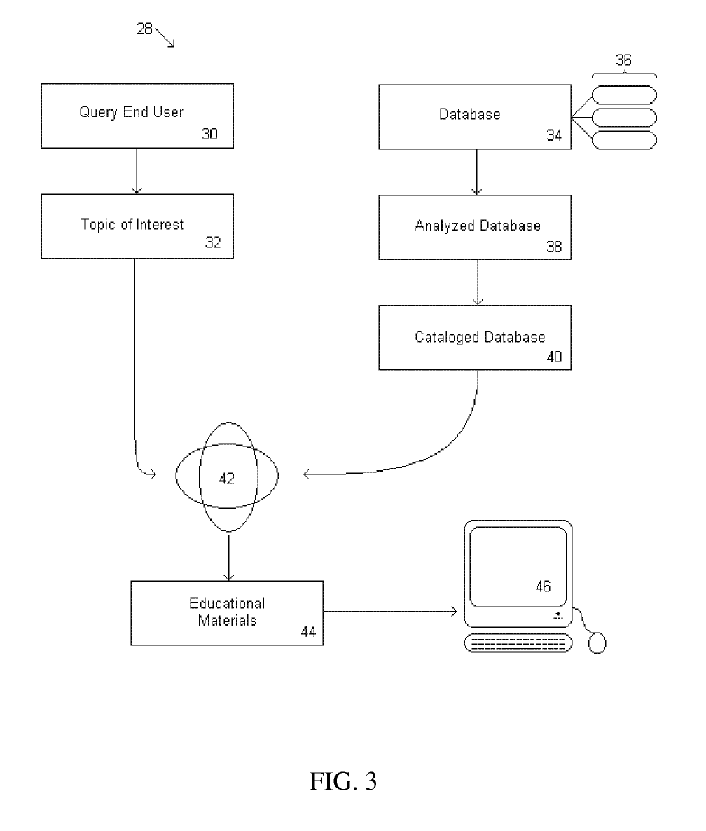

FIG. 3 depicts a flow chart of a personalized educational material selection process performed on a platform 28 in accordance with an embodiment of the invention. The flow chart shows a response to a query submitted by an end user 30, and the identification of a topic of interest 32 based on the query results. A topic algorithm operated on the platform may be used to compute responses to the query and determine the topic of interest 32. The flow chart further depicts a database 34, containing and having access to educational materials through at least one network 36. The database incorporates an analysis algorithm operated on the platform to analyze the educational materials in the database to produce an analyzed database 38. The analyzed database 38 is then cataloged based on subject, category, sub-category, articles, and further finite groupings if necessary, providing a cataloged database 40. The cataloged database 40 is established by incorporating a catalog algorithm operated on the platform 28. The cataloged database 40 is then cross-referenced with the topic of interest 32 determined for the end user, to identify specific educational material 44 for review by the end user. The specific educational material 44 is presented to the end user through a graphic user interface (GUI) 46, for the end user's edification.

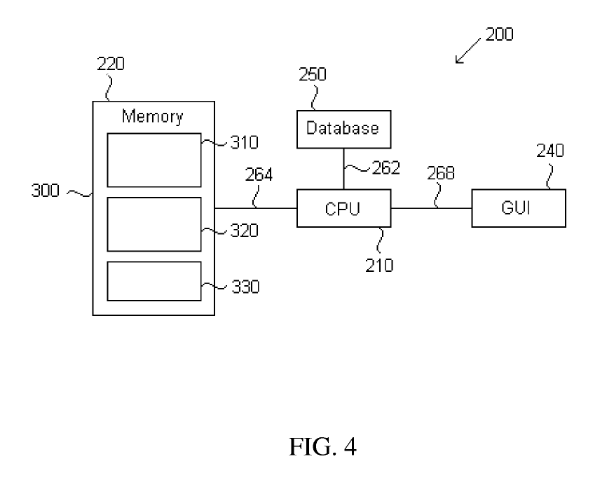

FIG. 4 is a block diagram of the components of the exemplary platform 200, in accordance with an embodiment of the invention. The platform 200 may include a programmable central processing unit (CPU) 210 which may be implemented by any known technology, such as a microprocessor, microcontroller, application-specific integrated circuit (ASIC), digital signal processor (DSP), or the like. The CPU 210 may be integrated into an electrical circuit, such as a conventional circuit board, that supplies power to the CPU 210. The CPU 210 may include internal memory and/or external memory 220 may be coupled thereto. The memory 220 may be coupled to the CPU 210 by a suitable internal bus 264.

The memory 220 may comprise random access memory (RAM), read-only memory (ROM), or other types of memory. The memory 220 contains instructions and data 310 that control the operation of the CPU 210. The memory 220 may also include a basic input/output system (BIOS) 320, which contains the basic routines that help transfer information between elements within the platform 200. The present invention is not limited by the specific hardware component(s) used to implement the CPU 210 or memory 220 components of the platform 200.

Optionally, the memory 220 may include external or removable memory devices 330 such as floppy disk drives and optical storage devices (e.g., CD-ROM, R/W CD-ROM, DVD, and the like). The platform 200 may also include one or more I/O interfaces (not shown) such as a serial interface (e.g., RS-232, RS-432, and the like), an IEEE-488 interface, a universal serial bus (USB) interface, a parallel interface, and the like, for the communication with removable memory devices such as flash memory drives, external floppy disk drives, and the like.

The platform 200 may also include a graphic user interface 240 such as a standard computer monitor, LCD, or other visual display. The user interface 240 may also include an audio system capable of playing an audible signal. The user interface 240 may permit the user to enter responses or commands into the platform 200. For example, the user may respond to a query in establishing a topic of interest computed by the platform 200. The user interface 240 may also comprise a means for accessing the database of educational material through a security protocol. The security protocol may prompt an end user to log-on to the platform by inputting a user name and password. The user interface 240 may include a standard keyboard, mouse, track ball, buttons, touch sensitive screen, wireless user input device and the like. The user interface 240 may be coupled to the CPU 210 by a suitable internal bus 268.

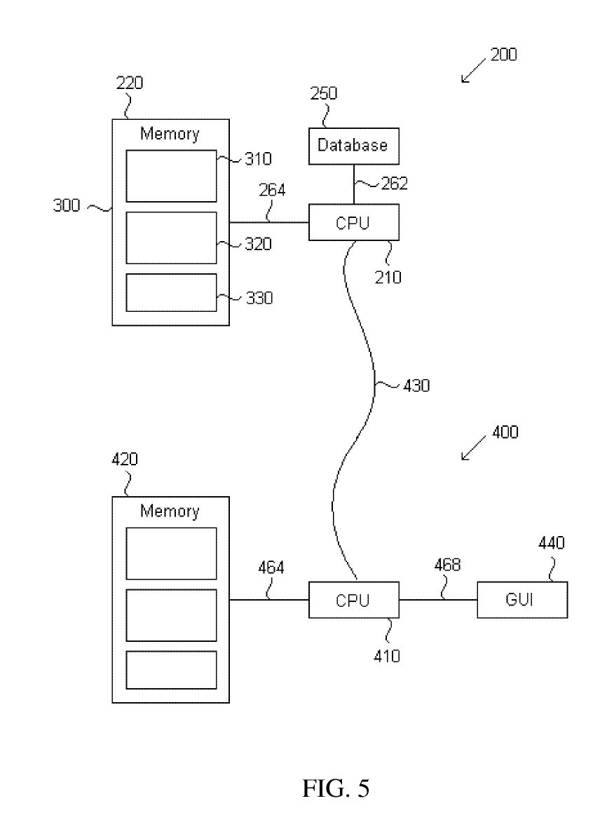

As shown in FIG. 5, the platform 200 may be in communication with at least one remote platform 400 for accessing the platform 200 through a network 430 (e.g., the Internet or other network). The remote platform 400 may be any suitable computer operative to access the platform 200. Such computers include desktop computers, laptop computers, mobile phones, tablet computers, and the like. The remote platform 400 may include a graphic user interface 440 such as a standard computer monitor, LCD, or other visual display. The user interface 440 may also include an audio system capable of playing an audible signal. The user interface 440 may permit the user to enter responses or commands into the platform 400 for interaction with the platform 200 through the network connection 430. For example, the user may respond to a query in establishing a topic of interest computed by the platform 200.

The user interface 440 may also comprise a means for accessing the database of educational materials through a security protocol. The security protocol may prompt an end user to log-on to the platform by inputting a user name and password. The user interface 440 may include a standard keyboard, mouse, track ball, buttons, touch sensitive screen, wireless user input device and the like. The user interface 440 may be coupled to the CPU 410 by an internal bus 468. The remote platform 400 may also include memory 420 coupled to the CPU 410 by an internal bus 464. The memory 420 may comprise random access memory (RAM) and read-only memory (ROM). The memory 420 may also include a basic input/output system (BIOS), which contains the basic routines that help transfer information between elements within the remote platform 400. The present invention is not limited by the specific hardware component(s) used to implement the CPU 410 or memory 420 components of the remote platform 400.

The platform 200 may also be in communication with an external database 250. The various components of the platform 200 may be coupled together by the internal buses 262, 264, and 268 (shown in FIG. 4). Each of the internal buses 262, 264, and 268 may be constructed using a data bus, control bus, power bus, I/O bus, and the like. The platform 200 may include instructions executable by the CPU 210 for operating the financial education methods and systems described herein. These instructions may include computer readable software components or modules stored in the memory 220, or stored and executed on one or more other computers of the platform.

In an alternative embodiment, the GUI may provide the option of creating a personalized financial educational plan by receiving specific information from the end user, and relating the specific information to form a topic of interest. The personalized financial education plan may lead the end user through at least two questions to determine and identify educational materials in a specific subject, a category, a subcategory or other areas of interest to the end user by incorporating a topic algorithm. The resulting educational materials aim to educate the end user in that specific subject, category, subcategory, or area of interest.

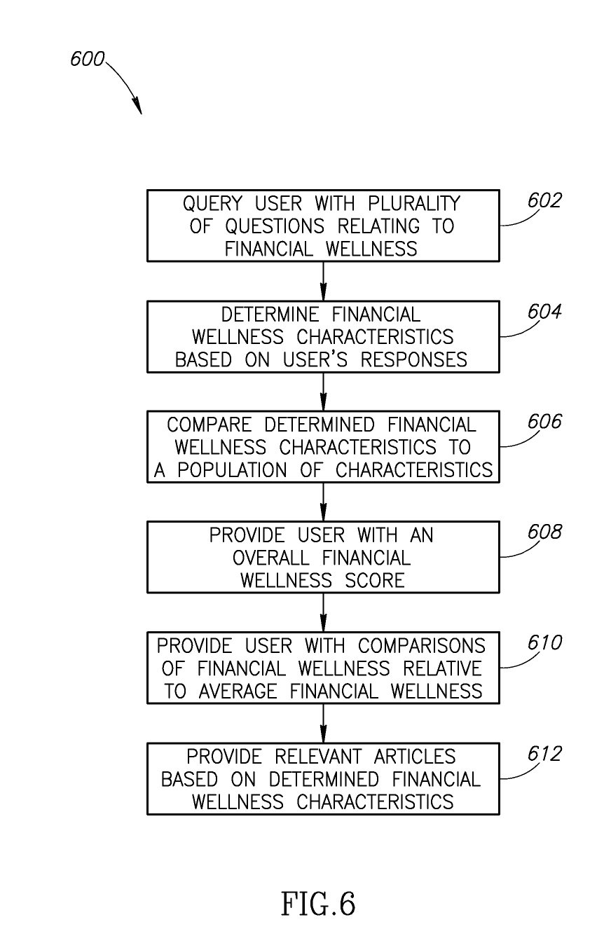

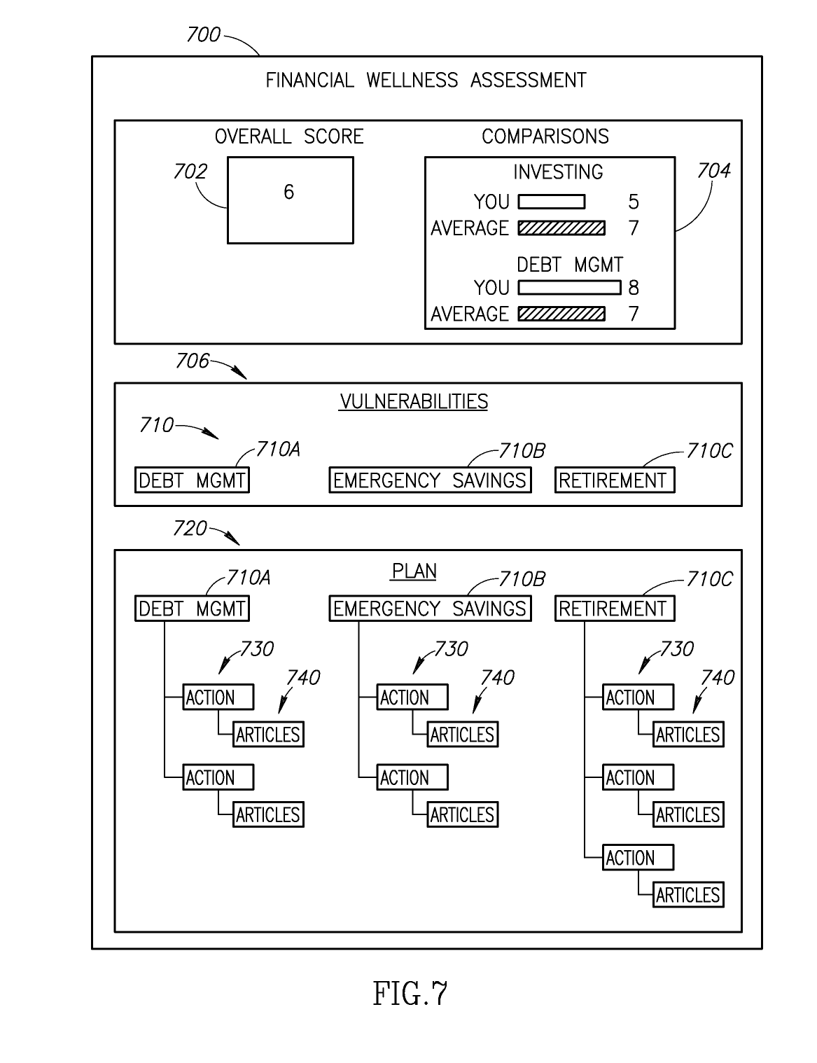

In an alternative embodiment, the personalized financial education plan prompts a series of questions to build a personalized learning plan and unique profile for each end user. Questions are aimed towards deciphering the knowledge of the end user in areas of finance, and may include ranking topics according to importance, demographics (e.g. age, income, dependants), and/or background questions aimed to determine the individual's familiarity with specific topics, such as investing, 401(k), retirement planning, IRAs, income taxes, or other finance, investing, financial planning, finance management or related matters. The questions may also be of a personal nature, such as inquiries regarding the individual's money management skills, comfort level in various investing strategies, types of investing and/or credit card balances, or financial tendencies. Furthermore, the questions may inquire about the individual's future plans, goals, expectations, or risk adversities. The general goal of the questions is to devise a personalized, in-depth understanding of the individual's finances, his/her needs and goals, and his/her understanding and knowledge of finance, investing, financial planning, finance management or related matters. The input of responses to the inquiries may be computed by a topic algorithm to determine the end user's topic of interest, and/or to generate a financial wellness assessment (see FIGS. 6 and 7). The topic of interest is cross-referenced with the cataloged educational materials by a correspondence algorithm and specific educational material supplementing deficiencies in the end user's knowledge base, of interest to the end user, or responsive to other criteria considered pertinent are presented to the end user.

FIG. 6 illustrates an exemplary process 600 for generating a personalized financial wellness assessment (or simply “assessment”) for a user utilizing a platform, such as the platform 200 discussed above. The process begins at block 602, by querying a user with a plurality of questions aimed towards deciphering the knowledge of the user in one or more areas of finance. The questions may be provided to the user by a GUI, as described above. The questions may include demographics information (e.g., age, income, dependents, or the like), and/or background questions configured to determine the user's financial characteristics, interests, concerns, familiarity with certain financial topics, and the like. As described above, the questions may also be of a personal nature (e.g., comfort level with certain financial topics).

In block 604, the platform may determine one or more financial wellness characteristics of the user based on his/her responses to the questions. The responses provided by the user may be computed by one or more algorithms to determine the one or more financial wellness characteristics. In block 606, the user's responses and/or determined financial wellness characteristics may be compared to a population of users that have also answered the same questions. As can be appreciated, it may be desirable for the user to understand how their financial wellness and knowledge compares to other individuals. The comparison may be made with all other users that have previously completed the financial wellness assessment, or any number of subsets of users (e.g., similarly situated users).

In block 608, the user is provided with an overall financial wellness score (see FIG. 7). The overall financial wellness score may be calculated by taking the user's responses to the questions and weighing them against optimal wellness standards in key areas of personal finance, as assessed by certified financial planners. In the example shown in FIG. 7, the user's overall financial wellness score is measured based on a scale of 1 to 10 to give the user a clear idea of his/her level of overall financial wellness. In block 610, the system may also provide the user with a comparison of the user's financial wellness relative to the financial wellness or other financial characteristics of other users.

In block 612, the system may also provide the user (e.g., via a GUI) with key areas of vulnerabilities, along with resources (such as educational articles) to help the user improve those areas. The key areas of vulnerabilities identified may or may not include topics selected by the user as key priorities. In general, the results provided to the user are intended to provide feedback and an analysis of his/her personal financial situation as would be provided if the user were working with a financial planner. Using the method discussed above, the user is directed to personalized information concerning topics of interest without the expense of working with a financial planner.

FIG. 7 illustrates an exemplary display window 700 showing the results of a user's financial wellness assessment. Although shown as a single window, the content of the display window 700 may be provided to the user in any suitable manner. The window 700 includes an overall financial wellness score 702 that provides the user with a “snapshot” of their overall financial wellness. As discussed above, the overall financial wellness score 702 may be calculated by taking the user's responses to the questions and weighing them against optimal wellness in multiple areas of personal finance. In the example shown in FIG. 7, the user's overall financial wellness score 702 is a 6 out of 10, giving the user an idea of his/her level of overall financial wellness.

The display window 700 also includes a comparisons section 704 that includes one or more comparisons between the user and an average (e.g., a national average, an average among one or more demographics, or the like). In some embodiments, the comparisons section 704 of the results window 700 may provide the user with scores in the areas the user indicated were the most important topics to them. These scores reflect the user's overall wellness in these categories, in comparison to other users of the system. In the example shown in FIG. 7, the user may have selected investing and debt management as two of his or her most important topics. The comparisons section 704 then provides the user with an indication of how they rank in these topics compared with other users of the system.

The display window 700 may also include a vulnerabilities section 706 that includes a list of vulnerable categories 710 or areas of concern based on the results of the user's questions. In the example provided, the user's vulnerabilities may include debt management 710A, emergency savings objectives 710B, and saving for retirement 710C. In addition to listing the user's vulnerabilities (or areas of concern), the vulnerabilities section 706 may also provide a general statement regarding vulnerability. For example, for debt management 710A, the section 706 may include a message indicating to the user that his/her monthly debt payments are costing them money that could otherwise be used to save for future goals.

The display window 700 may also include a plan section 720 devised to provide the user with information and steps to address the identified vulnerabilities or areas of concern 710. As shown, for each of the vulnerabilities 710A, 710B, and 710C listed in the vulnerabilities section 706, there is one or more actions 730 and associated articles 740 (or other information including spreadsheets, data, or other educational resources). As an example, the debt management category 710A may include a first action 730 relating, for example, to reducing credit card payments. Under this action, one or more articles 740 relating to credit card debt and payments may be provided. The debt management category 710A may also include a second action 730 relating, for example, to the order in which debt payments should be paid. This second action 730 may include one or more associated articles 740 relating to this topic (e.g., a debt payment plan calculator, articles regarding debt payment schedules, and the like). As with the debt management category 710A, the plan section 720 of the financial wellness assessment may include actions 730 and associated articles 740 with the emergency savings category 710B and the retirement savings category 710C as well. In addition to addressing the categories identified in the vulnerabilities section 706, the plan section 720 may also include information on other categories (e.g., categories of interest, priorities, requested information, and the like).

Other embodiments of the present invention are directed to methods and systems for aggregating and analyzing responses of a plurality of associated users (e.g., employees of a company or other organization) that have completed the aforementioned financial wellness assessment and education plan. Because the aggregated data is compiled from the responses provided by users to create their individual assessments and education plans, the content of their responses is not simply from a survey. That is, employees (or other associated users) answer the questions for a reason—to get the tools they need to find answers, information, and resources for their most pressing financial issues. Thus, the data is more reliable than simple survey data. In this regard, employers (or other associations or organizations) using this analyzed data are able to design an effective and impactful financial education program to address those issues.

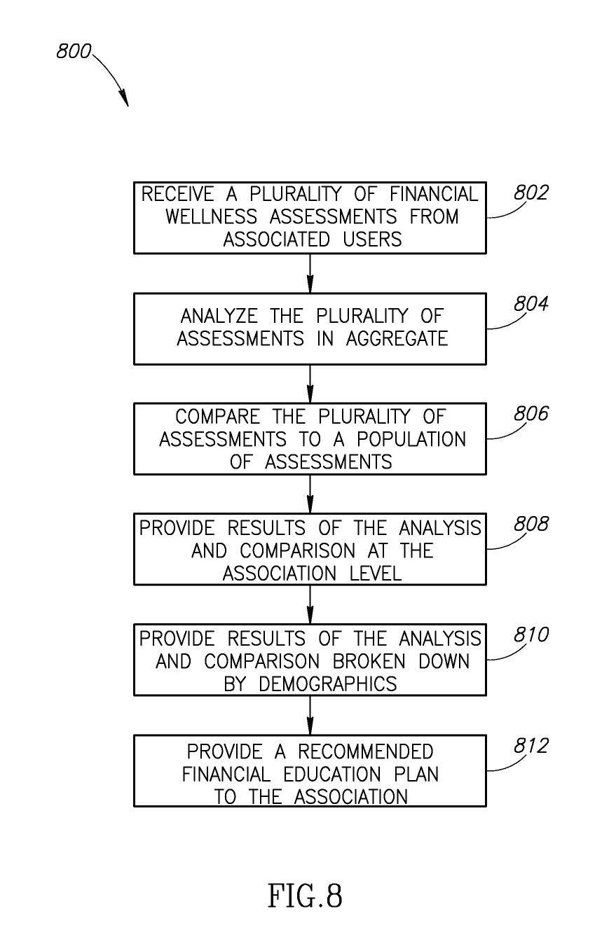

FIG. 8 illustrates a process 800 for generating and presenting a financial wellness assessment report for an organization, such as an employer or other organization. The process 800 may be executed on any suitable platform, such as the platform 200 described above. The process 800 begins at block 802 by receiving a plurality of financial wellness assessments from a plurality of users. For example, the system may receive the all the responses to the questions described above for all the employees of a company. As can be appreciated, the responses may first be “anonymized” so that each individual's responses are kept private.

In block 802, the anonymized responses and assessments (collectively “data”) are analyzed in aggregate according to one or more algorithms. The algorithms may be configured to analyze the responses to determine one or more characteristics of the users' responses. Such characteristics include financial priorities, indications of financial wellness, comfort levels with various financial topics, areas of concern, and the like. Additionally, in block 804, the data may be compared against a population of data to determine financial wellness characteristics of a company or organization relative to a larger group (e.g., a national average, an average of similar organizations, or the like).

To provide detailed and useful information for an association, the data may be analyzed both at the association level as well as broken down by demographics (e.g., age, income level, gender, geographic location, and the like). In this regard, associations may be able to tailor their financial education plans to address issues of particular groups within their association.

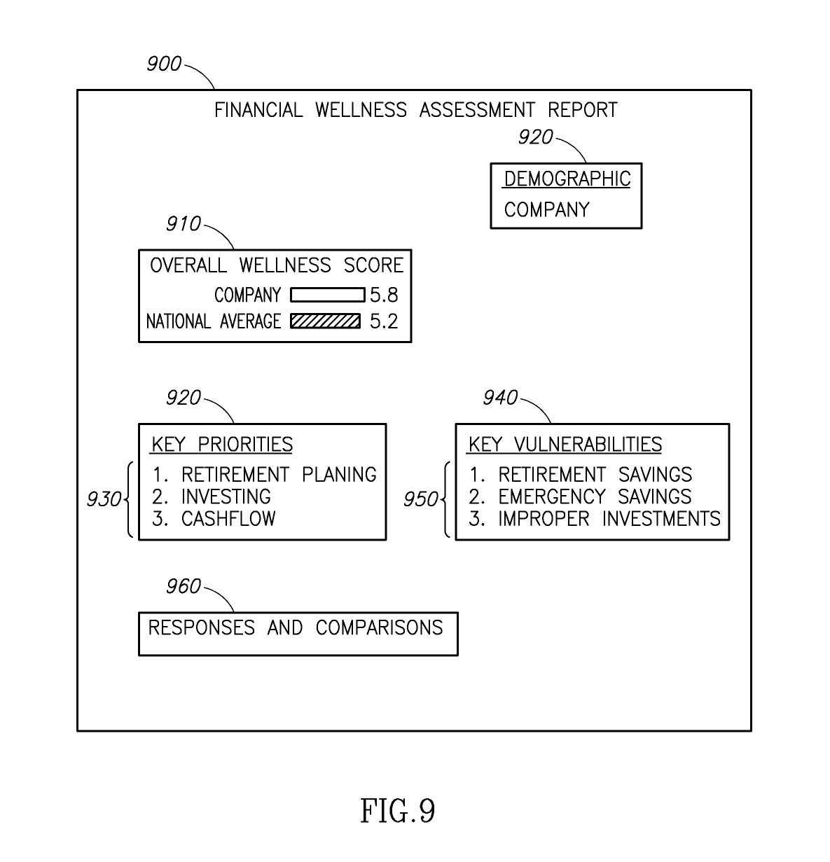

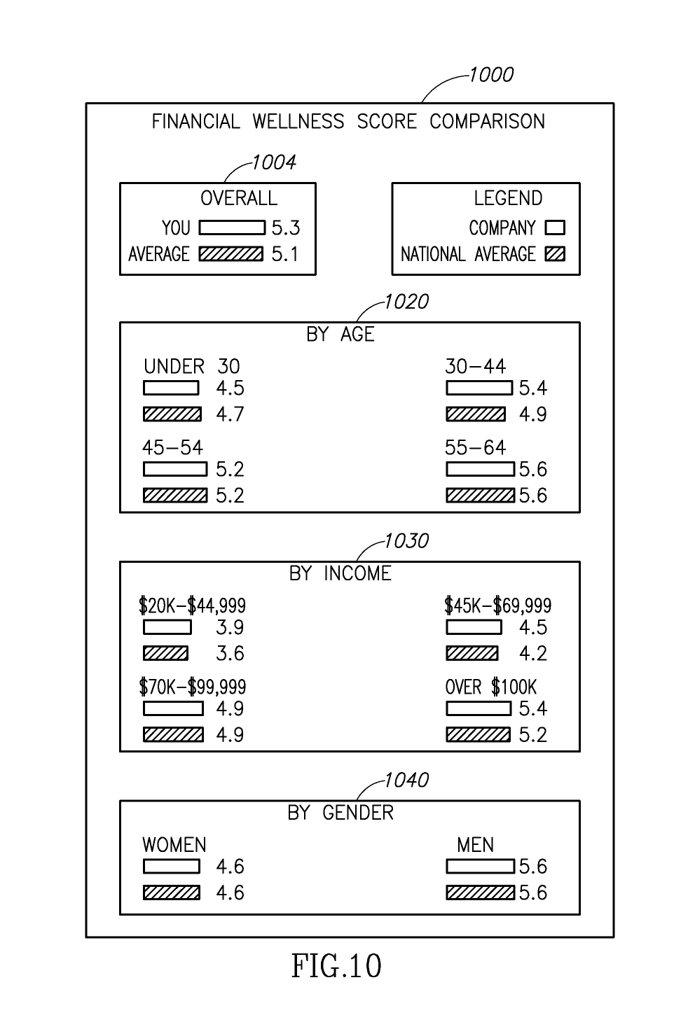

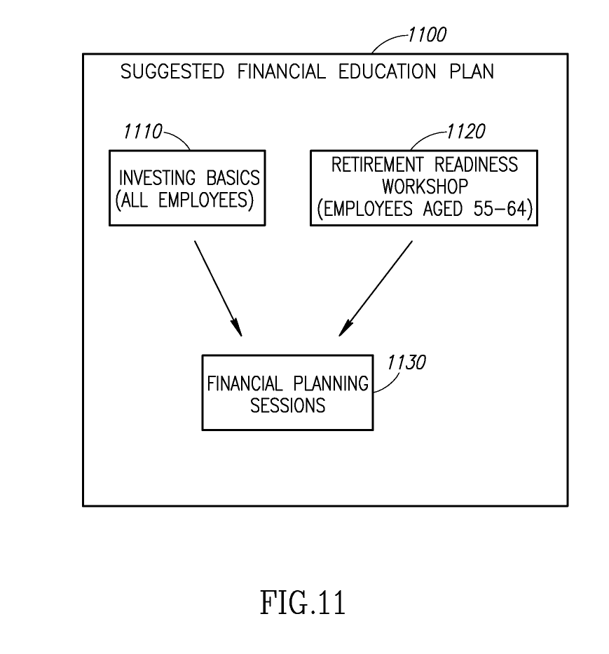

In blocks 808 and 810, the system provides the results of the analysis and the comparison at both the association level and broken down by one or more demographics. The results may include a summary of the data, one or more scores relating to financial wellness, comparisons, vulnerabilities, priorities, and the like. Examples of results data are provided in FIGS. 9 and 10 and discussed below. In addition to providing the results of the analysis and comparisons, in block 812 the system may provide a recommended financial education plan to the association based on the analysis of the gathered data (see FIG. 11).

FIG. 9 illustrates a simplified results window 900 (e.g., displayed on a suitable GUI) for providing a financial wellness assessment report to an organization. The window 900 may include a demographic section 920 to indicate the scope of the data provided in the window. In the example shown in FIG. 9, the demographic is the entire organization or “company,” but other similar windows may provide data for one or more subsets of the organization. The results window 900 also includes an overall financial wellness score section 910 that provides a wellness score for the company and the national average wellness score. The results window 900 also includes a key priorities section 920 that includes a list of priorities 930 identified by employees in their individual responses. The results window 900 further includes a key vulnerabilities section 940 that includes a list of vulnerabilities 950 identified by the system's one or more algorithms that were applied during the analysis described above (see block 804 of FIG. 8). In some embodiments, the results window 900 may also include a responses and comparisons section 960 that includes data regarding the employees' responses to questions and comparisons to responses across a larger population. As an example, the responses and comparisons section 960 may indicate that 8% of the company's employees responded that they feel confident that their investments are allocated appropriately, whereas 16% of all respondents nation-wide feel the same. Thus, a company is able to assess particular areas in which their employees may need or want further financially-related education.

As discussed above, the example provided in FIG. 9 illustrates a results window 900 for the entire company (i.e., the demographic section 920 indicates “company”). A plurality of windows similar to the results window 900 may be provided for other demographics. For example, the data may be presented broken down by age group, gender, income, geographic location, and the like.

FIG. 10 illustrates an example financial wellness score comparison window 1000 that may be provided so that associations may quickly get a “snapshot” of the overall financial wellness of its associates. The window 1000 may provide an overall score section 1004 that lists the average wellness score for an entire association. The overall score section 1004 may also include an average score so that the association may compare its financial wellness to similarly situated associations. The window 1000 may also include sections 1020, 1030, and 1040 that break down the financial wellness scores of the association by age (section 1020), by income (section 1030), by gender (section 1040), or by other criteria. Using this information, an association may be able to quickly assess the overall financial wellness of its members as well as particular subsets of its members.

FIG. 11 illustrates an example recommended or suggested financial education plan 1100 that may be included with the financial wellness assessment report. In this example, the plan 1100 recommends that all employees receive training and/or support regarding investing basics 1110. The plan 1100 also recommends that the association provide workshops or seminars that cover retirement readiness for employees aged 55-64. The plan 1100 may also include individual financial planning sessions 1130 with a certified financial planner for all employees to help them create and maintain an overall financial plan. In addition to specific recommended actions, the assessment report may also provide an analysis of the results to address an association's key vulnerabilities and to highlight its strengths.

Although the personalized financial education plan and assessment reports discussed above is concentric to finance, investing, financial planning, finance management or related matters, the methods and systems disclosed, as well as the platforms and algorithms devised, may be adopted for use in any and all topics of interest. For example the inventive methods and systems may be applied for providing personalized educational materials relating to real estate, politics, stocks, college, insurance, executive coaching, or virtually any topic of interest.

Various embodiments of the invention are described above in the Description of the Invention. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at the time of filing this application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention disclosed herein not be limited to the particular embodiments disclosed.

While particular embodiments of the invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.)

What is claimed is:

1. A method for providing educational material, comprising:
providing a database of educational material;
analyzing the educational material in the database;
cataloging the analyzed educational material;
querying an end user;
identifying at least one topic of interest based on the results of the query;
identifying educational material corresponding with the at least one topic of interest; and
presenting the corresponding educational material to the end user through a graphic user interface (GUI).

2. The method of claim 1, wherein the database is in communication with a network.

3. The method of claim 2, wherein the database is a catalog, a corporate manual, an electronic data source, or combinations thereof.

4. The method of claim 1, wherein analyzing the educational material in the database comprises the use of an analysis algorithm.

5. The method of claim 1, wherein cataloging the analyzed educational material comprises the use of a catalog algorithm.

6. The method of claim 1, wherein querying the end user comprises soliciting a response to a question, prompting a selection from at least two choices, soliciting a response to a yes/no question, soliciting an input, or combinations thereof.

7. The method of claim 1, wherein identifying at least one topic of interest based on the results of the query comprises the use of a topic algorithm.

8. The method of claim 1, wherein identifying educational material corresponding with the at least one topic of interest comprises the use of a correspondence algorithm.

9. The method of claim 1, wherein the topic of interest is finance, investing, financial planning, finance management, or combinations thereof.

10. The method of claim 1, further comprising supplementing the database with additional educational material.

11. The method of claim 1, further comprising accessing the database of educational material through a security protocol.

12. The method of claim 1, further comprising calculating a financial wellness score based on the results of the query by weighing the results against optimal wellness criteria in a plurality of areas of personal finance.

13. A computer-usable medium having readable instructions stored thereon that when executed by a processor, cause the processor to perform a method for providing education material, the method comprising:
accessing a database of educational material;
analyzing the educational material in the database;
cataloging the analyzed educational material;
querying an end user;
identifying at least one topic of interest based on the results of the query;
identifying educational material corresponding with the at least one topic of interest; and
presenting the corresponding educational material to the end user through a graphic user interface (GUI).

14. A method for providing a financial wellness assessment to a user, comprising:
presenting a plurality of questions to the user through a graphical user interface (GUI), the questions relating to one or more financial topics;
receiving responses to the plurality of questions from the user;
analyzing the responses received from the user according to a predetermined algorithm;
comparing the responses received from the user to a larger sample of responses;
determining an overall financial wellness score of the user based on the user's responses to the plurality of questions and predetermined financial wellness criteria;
presenting the overall financial wellness score to the user through the GUI; and
presenting to the user a comparison of a financial characteristic between the user and the larger sample.

15. The method of claim 14, further comprising:
identifying at least one topic of interest based on the responses received from the user;
identifying educational material corresponding with the at least one topic of interest; and
presenting the corresponding educational material to the user through the GUI.

16. The method of claim 14, further comprising:
identifying at least one vulnerability of the user based on the responses received from the user; and
presenting educational material corresponding to the identified vulnerability to the user through the GUI.

17. The method of claim 14, wherein at least one of the plurality of questions relates to the user's priorities regarding financial topics, the method further comprising:
presenting a comparison between the user and the larger sample relating to a financial topic that the user has indicated to be a priority.

18. A method for providing a financial wellness assessment report for an association, comprising:
receiving a plurality of responses to a financial wellness assessment for a plurality of associated users;
analyzing the responses in aggregate according to an algorithm to determine one or more financial wellness characteristics of the association;
comparing the responses to a larger sample of responses; and
providing results of the analysis to the association.

19. The method of claim 18, further comprising providing a recommended financial education plan to the association based on the analyzed responses.

20. The method of claim 18, wherein providing results comprises providing results based on demographic information for the members of the association.

21. The method of claim 20, wherein the demographic information includes one or more of age, income, gender, and geographic location.

22. The method of claim 18, wherein analyzing comprises calculating an overall financial wellness score and component scores for a plurality of areas of personal finance, and wherein providing results comprises providing the scores to the association.

23. A computer-usable medium having readable instructions stored thereon that when executed, cause a processor to perform a method for providing a financial wellness assessment report for an association, the method comprising:
receiving responses to a financial wellness assessment for a plurality of associated users;
analyzing the responses in aggregate according to an algorithm to determine one or more financial wellness characteristics of the association;
comparing the responses to a larger sample of responses; and
providing results of the analysis to the association.

24. A system for providing a financial wellness assessment report for an association, comprising:
a computer comprising a processor operative to execute instructions to perform a method for providing a financial wellness assessment report for an association, the method comprising:
receiving responses to a financial wellness assessment for a plurality of associated users;
analyzing the responses in aggregate according to an algorithm to determine one or more financial wellness characteristics of the association;
comparing the responses to a larger sample of responses received from other associations; and
providing results of the analysis to the association.
